(19) United States
(12) Patent Application Publication
(10) Pub. No.: US 2026/0086533 A1
(43) Pub. Date: Mar. 26, 2026

(54) METHOD OF MANUFACTURING A STACKED ASSEMBLY

(71) Applicant: Krauss-Maffei Corporation, Brighton, MI (US)

(72) Inventor: Chad RANDOLPH, Perry, MI (US)

(21) Appl. No.: 18/897,618

(22) Filed: Sep. 26, 2024

(51) Int. Cl. G05B 19/4155; B23K 26/362

(52) U.S. Cl. CPC G05B 19/4155; B23K 26/362; G05B 2219/45212

(57) ABSTRACT

A method is provided for manufacturing a stacked assembly using an assembling machine having a first machine body and a second machine body. The method includes providing a first component; providing a second component having a score pattern and a marking pattern formed thereon; fixing the first component relative to the first machine body; arranging the second component relative to the second machine body such that the marking pattern satisfies a predetermined condition; and then fixing the second component relative to the second machine body while the marking pattern satisfies the predetermined condition. The method further includes moving at least one of the first machine body and second machine body relative to the other such that the first and second machine bodies assume a stacking configuration, and then fixing the second component relative to the first component while the first and second machine bodies are in the stacking configuration.

### TECHNICAL FIELD

The present disclosure relates to a method of manufacturing a stacked assembly and more particularly, a method of manufacturing a trim assembly for a vehicle interior.

### BACKGROUND OF THE INVENTION

Conventionally, a trim assembly for a vehicle interior can include a support substrate, an airbag module affixed to a rear side of the support substrate, and a decorative skin that covers and conceals a front side of the support substrate. During a collision, the airbag module may deploy an airbag, which penetrates through the support substrate and skin into the vehicle interior. To facilitate this penetration, the support substrate and skin can each comprise a weakened area that will break open in response to force from the airbag. For example, the support substrate and skin can each comprise a weakened area having a score line that reduces the thickness of the substrate/skin in that area and thus reduces the area’s mechanical strength.

Notably, it is preferable that the weakened areas of the support substrate and skin are properly aligned to ensure proper deployment of the airbag. However, the weakened areas may be difficult to visually detect and align, particularly weakened areas that comprise a shallow score line that is difficult to see by the unaided human eye. Accordingly, it would be advantageous to provide a method of manufacturing a trim assembly or other stacked assemblies that facilitates alignment of weakened areas.

### BRIEF SUMMARY OF THE INVENTION

The following presents a simplified summary of example embodiments of the invention. This summary is not intended to identify critical elements or to delineate the scope of the invention.

In accordance with a first aspect, a method is provided for manufacturing a stacked assembly using an assembling machine having a first machine body and a second machine body. The method includes providing a first component; providing a second component to be stacked with the first component, the second component having a score pattern and a marking pattern formed thereon; arranging the first component relative to the first machine body, and then fixing the first component relative to the first machine body; arranging the second component relative to the second machine body such that the marking pattern satisfies a predetermined condition, and then fixing the second component relative to the second machine body while the marking pattern satisfies the predetermined condition; moving at least one of the first machine body and second machine body relative to the other of the first machine body and second machine body such that the first machine body and second machine body assume a stacking configuration; and fixing the second component relative to the first component while the first machine body and second machine body are in the stacking configuration.

According to a second aspect, a method is provided for manufacturing a first stacked assembly and a second stacked assembly using an assembling machine having a first machine body and a second machine body. The first stacked assembly and second stacked assembly are each manufactured by providing a first component; providing a second component to be stacked with the first component, the second component having a score pattern and a marking pattern formed thereon such that the score pattern and marking pattern have a spatial relationship; arranging the first component relative to the first machine body, and then fixing the first component relative to the first machine body; arranging the second component relative to the second machine body such that the marking pattern satisfies a predetermined condition that is based on the spatial relationship, and then fixing the second component relative to the second machine body while the marking pattern satisfies the predetermined condition; moving at least one of the first machine body and second machine body relative to the other of the first machine body and second machine body such that the first machine body and second machine body assume a stacking configuration; and fixing the second component relative to the first component while the first machine body and second machine body are in the stacking configuration. The spatial relationship between the score pattern and marking pattern of the first stacked assembly is the same as the spatial relationship between the score pattern and marking pattern of the second stacked assembly.

Preferably, according to the first and/or second aspect, the score pattern and marking pattern have a spatial relationship, and the predetermined condition is based on the spatial relationship.

Preferably, according to the first and/or second aspect, the assembling machine includes a marking detection system configured to determine if the marking pattern satisfies the predetermined condition, the marking detection system comprising a controller with a memory that stores the predetermined condition.

Preferably, according to the first and/or second aspect, the marking detection system further includes a camera that is operable to capture an image of the marking pattern, and a display that is operable to display the image of the marking pattern, wherein the controller is operatively coupled to the camera and display.

Preferably, according to the first and/or second aspect, the controller is configured to operate the display to indicate whether the predetermined condition is satisfied.

Preferably, according to the first and/or second aspect, the controller is configured to operate the display to show a target corresponding to the predetermined condition.

Preferably, according to the first and/or second aspect, the step of providing the second component includes providing a component body, scoring the component body to form the score pattern, and forming the marking pattern on the component body.

Preferably, according to the first and/or second aspect, the spatial relationship is predetermined prior to forming the score pattern and/or marking pattern, and the score pattern and marking pattern are formed to have the spatial relationship.

Preferably, according to the first and/or second aspect, the spatial relationship is determined after the score pattern and marking pattern are formed.

Preferably, according to the first and/or second aspect, the marking pattern is formed on the component body via laser etching.

Preferably, according to the first and/or second aspect, the marking pattern is formed on the component body based on a material and/or color of the component body.

Preferably, according to the first and/or second aspect, the step of providing the second component includes using a processing machine to form the marking pattern on the component body, the processing machine comprising a laser etching device and a controller operatively coupled to the laser etching device, wherein the spatial relation is stored in a memory of the controller, and the controller is configured to operate the laser etching device to form the marking pattern such that the score pattern and marking pattern have the spatial relationship.

Preferably, according to the first and/or second aspect, the marking pattern comprises one or more markings, each marking comprising a first line and a second line that is transverse to the second line and meets or intersects with the first line.

Preferably, according to the first and/or second aspect, a foam material is injected between the first component and the second component while the first machine body and second machine body are in the stacking configuration.

Preferably, according to the first and/or second aspect, the stacked assembly is a vehicle trim assembly, the first component is a support substrate of the vehicle trim assembly, and the second component is a skin of the vehicle trim assembly.

Preferably, according to the first and/or second aspect, an airbag module is affixed to the first component.

Preferably, according to the first and/or second aspect, the step of providing the second component includes providing a component body, scoring the component body to form the score pattern, and operating a laser etching device based on a material and/or color of the component body to form the marking pattern on the component body via laser etching.

Preferably, according to the second aspect, the component body for the first stacked assembly comprises a first material, the component body for the second stacked assembly comprises a second material that is different from the first material, when manufacturing the first stacked assembly, the laser etching device is operated to apply a first amount of energy per area to the component body for the first stacked assembly, and when manufacturing the first stacked assembly, the laser etching device is operated to apply a second amount of energy per area to the component body for the second stacked assembly that is different from the first amount of energy per area.

Preferably, according to the second aspect, the component body for the first stacked assembly comprises a first color, the component body for the second stacked assembly comprises a second color that is lighter than the first color, when manufacturing the first stacked assembly, the laser etching device is operated to apply a first amount of energy per area to the component body for the first stacked assembly, and when manufacturing the first stacked assembly, the laser etching device is operated to apply a second amount of energy per area to the component body for the second stacked assembly that is greater than the first amount of energy per area.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is an exploded view of an example trim assembly for a vehicle interior;

FIG. 2 is an enlarged rear view of a support substrate of the trim assembly;

FIG. 3 is an enlarged front view of the support substrate, with a reinforcement member attached thereto;

FIG. 4 is an enlarged rear view of a skin of the trim assembly;

FIG. 5 is a flowchart showing an example method of manufacturing the trim assembly;

FIG. 6 is a schematic view of an example skin-processing machine for scoring and laser etching the skin of the trim assembly;

FIG. 7 is a perspective view of an example assembling machine for assembling the trim assembly;

FIG. 8 is an enlarged view of a display of the assembling machine;

FIG. 9 is a cross-section view showing the assembling machine, the support substrate, and the skin during a step of arranging the assembling machine in a stacking configuration with the support substrate and skin loaded on the assembling machine; and

FIG. 10 is a cross-section view showing the assembling machine, the support substrate, and the skin during a step of fixing the support substrate and skin together with a foam layer.

### DETAILED DESCRIPTION

The following is a detailed description of illustrative embodiments of the present application. As these embodiments of the present application are described with reference to the aforementioned drawings, various modifications or adaptations of the methods and or specific structures described may become apparent to those skilled in the art. All such modifications, adaptations, or variations that rely upon the teachings of the present application, and through which these teachings have advanced the art, are considered to be within the spirit and scope of the present application. Hence, these descriptions and drawings are not to be considered in a limiting sense as it is understood that the present application is in no way limited to the embodiments illustrated. Moreover, certain terminology is used herein for convenience only and is not to be taken as a limitation. Still further, in the drawings, the same reference numerals are employed for designating the same elements.

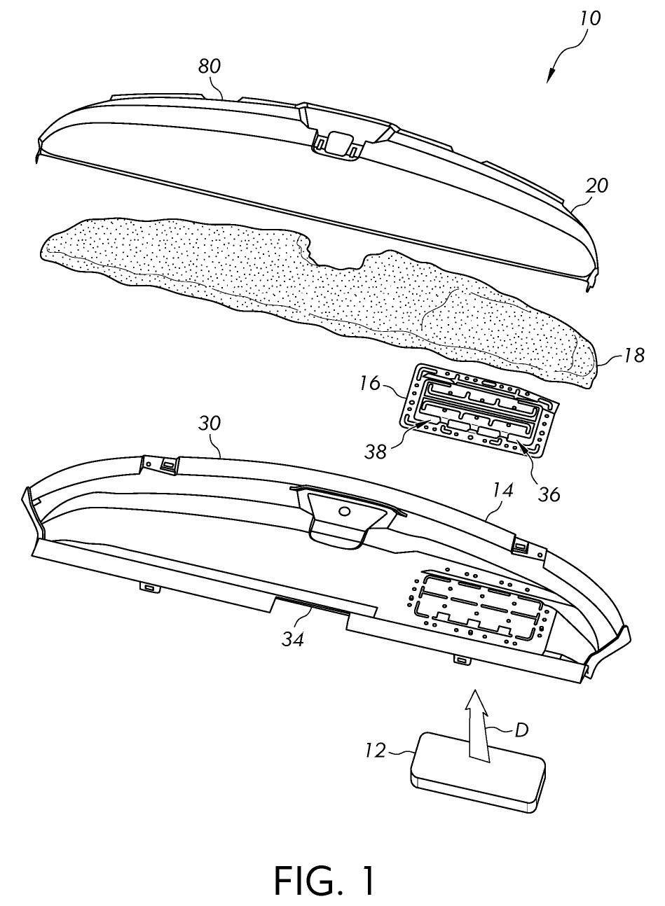

FIG. 1 shows an example trim assembly 10 for a vehicle interior. The trim assembly 10 in the present example is configured for a dashboard of a vehicle interior. However, it is to be appreciated that the trim assembly 10 may be configured for a different portion of a vehicle interior without departing from the scope of the disclosure. For example, the trim assembly 10 may be configured for a door panel, a dash panel, a steering wheel cover, or a roof panel, among various other vehicle parts. Broadly speaking, the trim assembly 10 may be configured for any portion of a vehicle interior wherein an airbag or other safety device is provided.

The trim assembly 10 is a stacked assembly comprising an airbag module 12, a support substrate 14 (e.g., first component), a reinforcement member 16, a foam layer 18, and a skin 20 (e.g., second component), which are stacked and fixed together. The support substrate 14 is a rigid body that can be mounted within a vehicle to support the other components of the trim assembly 10. Moreover, the skin 20 is a relatively thin layer of material that is intended to cover and conceal the underlying components of the trim assembly 10.

As used herein, the terms “front”, “rear”, “forward”, “rearward”, and the like refer to directions, orientations, or arrangements of features relative to the vehicle interior in which the trim assembly 10 will be mounted. That is, the terms “front”, “forward”, and the like refer to directions, orientations, or arrangements that will face or be closer the interior, whereas the terms “rear”, “rearward”, and the like refer to directions, orientations, or arrangements that will face away from or be farther from the interior. For example, the skin 20 of the trim assembly 10 is arranged forward from or in front of the support substrate 14, since the skin 20 will be closer to the vehicle interior.

The airbag module 12 of the trim assembly 10 can be any module having a casing that supports and/or contains an inflatable airbag. One example airbag module is disclosed in U.S. Patent Application Publication No. 2013/0076010, which is hereby incorporated by reference in its entirety. Moreover, the casing of the airbag module 12 can be affixed to a rear side of the support substrate 14 (e.g., via adhesive, fasteners, clips, etc.) such that deployment (i.e., inflation) of its airbag will cause the airbag to deploy relative to the support substrate 14 in an opening (e.g., forward) direction D. As discussed further below, this deployment of the airbag will apply force to associated door portions of the support substrate 14 and skin 20, causing those door portions to break open and provide an opening for the airbag to deploy therethrough.

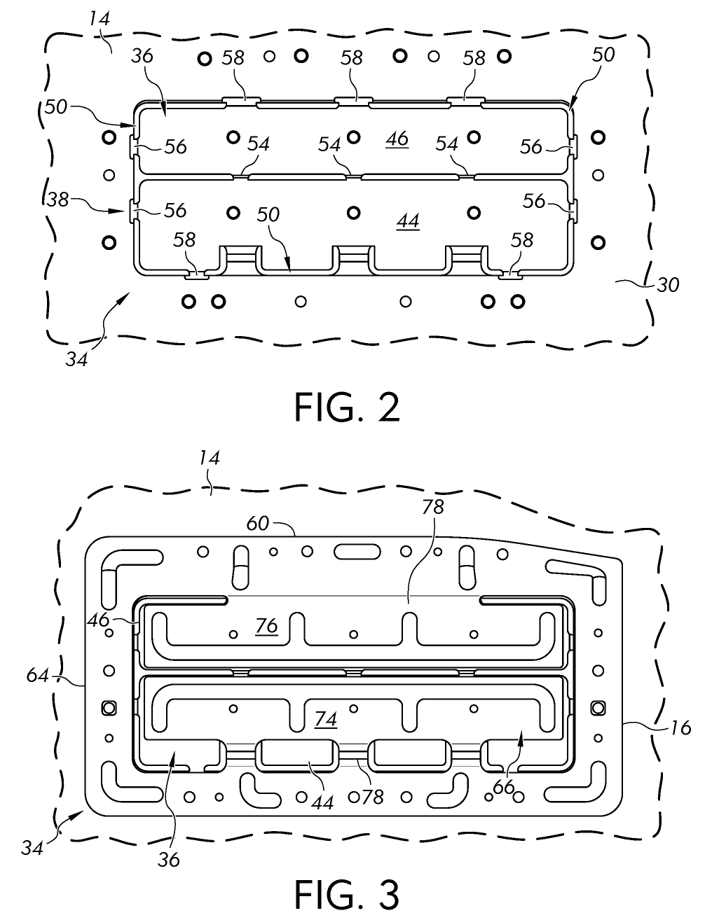

The support substrate 14 of the trim assembly 10 comprises a single, monolithic body 30 of material (e.g., comprising polypropylene with glass fillers, acrylonitrile butadiene styrene (ABS) with or without fillers, polycarbonate with or without fillers, etc.) that includes a main portion 34, a door portion 36, and a weakened portion 38 that fixes the door portion 36 relative to the main portion 34 in a closed configuration. As shown best in FIG. 2, the door portion 36 includes first and second doors 44, 46, which are defined by a plurality of perforations 50 extending through the substrate body 30. Meanwhile, the weakened portion 38 comprises a plurality of link members 54, 56, 58 defined between the perforations 50.

The link members 54, 56, 58 of the weakened portion 38 connect the first and second doors 44, 46 to each other and the main portion 34, thereby fixing the door portion 36 relative to the main portion 34 in the closed configuration. Moreover, each link member 54, 56, 58 is relatively short in length (measured along the line of perforation) and has a reduced thickness (measured in the opening direction D) compared to adjacent segments of the doors 44, 46 and main portion 34 connected thereto. Accordingly, each link member 54, 56, 58 of the weakened portion 38 is mechanically weaker than adjacent segments of the door portion 36 and/or main portion 34 in the opening direction D, since it can withstand less shearing force in the opening direction D than those adjacent segments.

As shown in FIG. 3, the reinforcement member 16 can be fixed to a front side of the support substrate 14 to reinforce and further strengthen the segments of the door portion 36 and main portion 34 adjacent to the link members 54, 56, 58. The reinforcement member 16 comprises a single, monolithic body 60 of material (e.g., steel) that includes a frame 64 and a door portion 66 flexibly coupled to the frame 64. In particular, the door portion 66 includes first and second doors 74, 76, wherein each door 74, 76 is flexibly coupled to the frame 64 via one or more hinge portions 78. The frame 64 can be fixed (e.g., adhered) to the main portion 34 of the support substrate 14 to reinforce segments of the main portion 34 adjacent to the link members 56, 58. Meanwhile, the first and second doors 74, 76 of the reinforcement member 16 can be respectively fixed (e.g., adhered) to the first and second doors 44, 46 of the support substrate 14 to reinforce segments of the first and second doors 44, 46 adjacent to the link members 54, 56, 58.

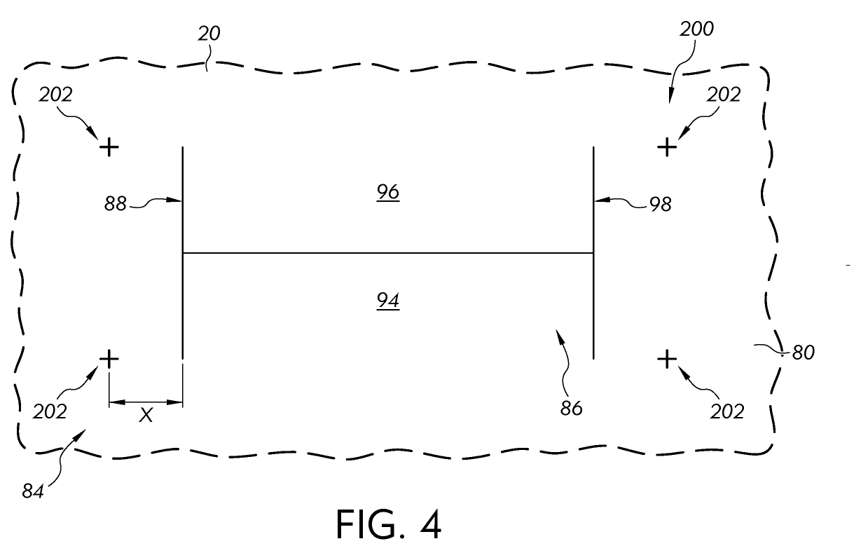

As schematically shown in FIG. 4, the skin 20 comprises a single, monolithic body 80 of material (e.g., comprising polyvinyl chloride (PVC), thermoplastic polyolefin (TPO), etc.) that includes a main portion 84, a door portion 86, and a weakened portion 88 that fixes the door portion 86 relative to the main portion 84 in a closed configuration. The door portion 86 includes first and second doors 94, 96, and the weakened portion 88 is a continuous, H-shaped portion of the component body 80 that connects the first and second doors 94, 96 to each other and the main portion 84.

The skin body 80 is a thin body of material having a generally uniform thickness of about, for example, 1.2 mm. However, a rear side of the weakened portion 88 is scored such that the weakened portion 88 has a smaller thickness of about, for example, 0.5 mm. In particular, the weakened portion 88 has a continuous, H-shaped score pattern 98 formed thereon, which reduces the thickness of the weakened portion 88 compared to adjacent segments of the door portion 86 and main portion 84. Accordingly, the weakened portion 88 is mechanically weaker than adjacent segments of the door portion 86 and main portion 84 in the opening direction D, since it can withstand less shearing force in the opening direction D than those adjacent segments.

As discussed above, the airbag module 12 is affixed to a rear side of the support substrate 14 such that deployment (i.e., inflation) of its airbag will cause the airbag to deploy relative to the support substrate 14 in the opening direction D. As the airbag deploys in the opening direction D, it will apply force against the door portion 36 of the support substrate 14 in the opening direction D that is sufficient to break at least the link members 54, 56 of the weakened portion 38, thereby opening the door portion 36. The applied force may also break the link members 58, although some or all of the link members 58 may remain intact in some examples. In either case, the doors 44, 46 will remain hinged to the main portion 34 via the reinforcement member 16 and its hinge portions 78. Moreover, the reinforcement member 16 will strengthen the main portion 34 and door portion 36 and help prevent those portions from breaking during deployment of the airbag.

As the airbag continues to deploy in the opening direction D, it will force the doors 44, 46 of the support substrate 14 to swing open in the forward direction. The doors 44, 46 will apply forward force to the foam layer 18, which in turn will apply forward force to the door portion 86 of the skin 20. These forces will break the foam layer 18 and the weakened portion 78 of the skin 20, thereby opening the door portion 86 of the skin 20 and permitting the airbag to deploy through the foam layer 18 and skin 20 in the opening direction D.

The trim assembly 10 as described above is thus configured such that deployment of the airbag module 12 will cause the airbag to deploy in the opening direction D, thereby breaking the weakened portions 38, 88 of the support substrate 14 and skin 20, as well as the foam layer 18 therebetween. This will permit the airbag to deploy through the support substrate 14, foam layer 18, and skin 20, into the vehicle interior.

However, it is to be appreciated that the trim assembly 10 may comprise other configurations without departing from the scope of the disclosure. For instance, the support substrate 14, reinforcement member 16, and skin 20 in the present embodiment all have dual-door configurations that will break open as the airbag module 12 deploys. However, the support substrate 14, reinforcement member 16, and skin 20 may have single-door configurations in other examples, or multi-door configurations with three or more doors. Moreover, the weakened portions 38, 88 of the support substrate 14 and skin 20 may have other configurations to mechanically weaken those portions 38, 88 relative to adjacent segments of their connected structures. For instance, the weakened portion 38 of the support substrate 14 may be a continuous portion of material that is scored, similar to the weakened portion 88 of the skin 20. Still further, the reinforcement member 16 and foam layer 18 are optional and may be excluded in some embodiments. Broadly speaking, the trim assembly 10 can comprise any stacked assembly having an airbag module and first and second components, wherein the first and second components each have a weakened portion that will break as the airbag is deployed to allow the airbag to deploy through the first and second components.

As can be appreciated from the description above, it is preferable that the weakened portions 38, 88 of the support substrate 14 and skin 20 are aligned with each other and the airbag module 12 to ensure proper deployment of the airbag through the door portions 36, 86 of both of the support substrate 14 and skin 20. Indeed, it is preferable that a maximum deviation between associated portions of the weakened portions 38, 88 is about +/- 2 mm or less (measured in a direction perpendicular the opening direction D). Otherwise, the airbag module 12 may not properly deploy and/or break undesired portions of support substrate 14 and skin 20.

Properly aligning the airbag module 12 with the weakened portion 38 of the support substrate 14 can be relatively simple, since the perforations 50 and link members 54, 56, 58 defined thereby are easily visible and can be visually aligned with the airbag module 12. However, properly aligning the weakened portion 88 of the skin 20 with the weakened portion 38 of the support substrate 14 can be more challenging, since the weakened portion 88 of the skin 20 is often difficult to visually detect. Although the weakened portion 88 is scored, the depth of the score line is relatively small (e.g., 0.7 mm or less) and therefore can be difficult to see.

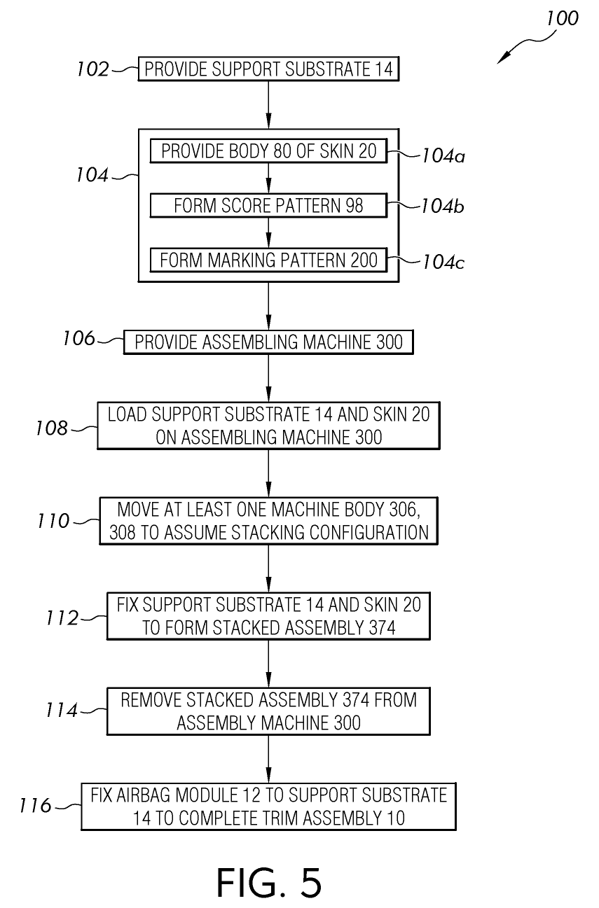

Accordingly, FIG. 5 shows a flowchart of an example method 100 for manufacturing the trim assembly 10, which can help facilitate proper alignment of the weakened portions 38, 88 of the support substrate 14 and skin 20. The method 100 includes an initial step 102 of providing the support substrate 14 and reinforcement member 16 optionally fixed thereto. For example, the support substrate 14 may be formed via an injection molding process wherein a thermoplastic material (e.g., comprising polypropylene, acrylonitrile butadiene styrene (ABS), polycarbonate, etc.) is injected into a mold to form the support substrate 14 and its features described above. Then, the frame 64, first door 74, and second door 74 of the reinforcement member 16 can be respectively fixed (e.g., adhered) to the main portion 34, first door 44, and second door 46 of the support substrate 14 to reinforce those segments. Alternatively, the support substrate 14 may be provided in a pre-formed condition, with or without the reinforcement member 16 affixed thereto.

The method 100 includes a further step 104 of providing the skin 20. In particular, the step 104 includes a first sub-step 104a of providing the body 80 of the skin 20, a second sub-step 104b of scoring the body 80 to form the score pattern 98, and a third sub-step 104c of forming a visible marking pattern 200 (see FIG. 4) on the body 80. The marking pattern 200 can be any configuration of one or more visible markings 202 formed on the body 80. For example, the marking pattern 200 in the present embodiment comprises four markings 202 provided near associated endpoints of the score pattern 98. Each marking 202 preferably comprises two or more lines that are transverse to each other and intersect or meet at a common end point. For example, each marking 202 in the present embodiment comprises two lines that are perpendicular to and intersect each other to form a crosshair shape. In other examples, each marking 202 may comprise a polygonal shape (e.g., triangle, square, etc.), wherein adjacent line segments of the shape are transverse to each other and meet at a common end point. Nevertheless, each marking 202 may comprise a single line, a single point, or any other shape without departing from the scope of the disclosure.

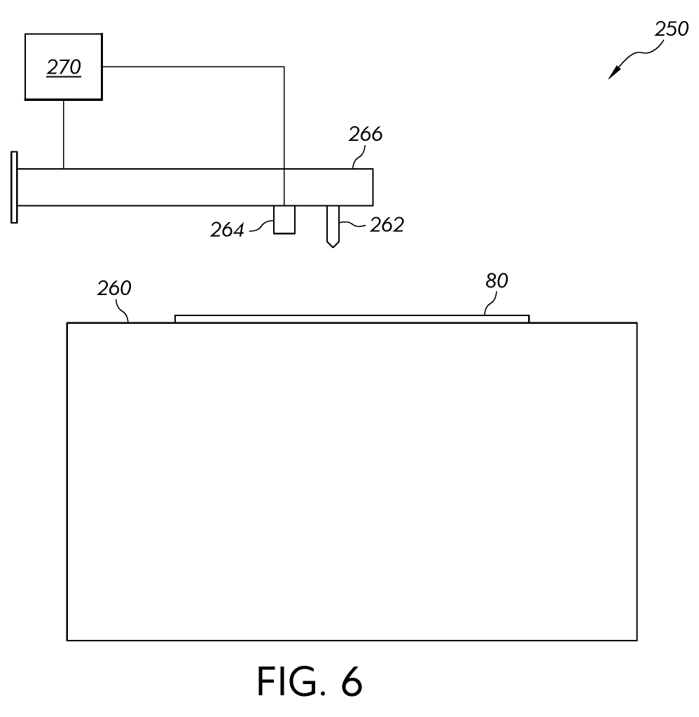

To form the score pattern 98 and marking pattern 200, a skin-processing machine 250 (see FIG. 6) can be provided that includes a cell 260, a scoring tool 262, a laser etching device 264, a robot arm 266, and a controller 270 that is operatively coupled to the robot arm 266 and laser etching device 264. The scoring tool 262 and laser etching device 264 are coupled to the robot arm 266, which is movable relative to the cell 260. The scoring tool 262 can be any conventional tool (e.g., knife, needle, etc.) for scoring material. Moreover, the laser etching device 264 can be any conventional device that is operable to generate a laser for etching material. For instance, example laser etching devices are disclosed in U.S. Patent No. 8,598,489 and International Publication No. WO2018/058966, which are hereby incorporated by reference in their entirety.

To form the score pattern 98 and marking pattern 200, the body 80 of the skin 20 can be loaded onto the cell 260 of the skin-processing machine 250, and then the controller 270 can operate the robot arm 266 to move the scoring tool 262 and score the body 80. Before, during, or after this scoring operation, the controller 270 can also operate the laser etching device 264 to laser-etch the body 80 and form the marking 200. Preferably, the controller 270 can operate the robot arm 266 and laser etching device 264 to respectively score and mark the body 80 simultaneously.

The score pattern 98 and marking pattern 200 are formed in step 104 such that they have one or more known spatial relationships. For example, each marking 202 in the present embodiment is arranged relative to an associated endpoint of the score pattern 98 such that the marking’s vertical line (as viewed in FIG. 4) is parallel with the score pattern 98 and spaced from the score pattern 98 by a known distance X (see FIG. 4). Moreover, each marking 202 is arranged such that its horizontal line (as viewed in FIG. 4) is vertically aligned with its associated endpoint of the score pattern 98.

In some embodiments, one or more spatial relationships between the score pattern 98 and marking pattern 200 can be predetermined prior to forming the score pattern 98 and/or marking pattern 200, and then the controller 270 can operate the robot arm 266 and laser etching device 264 to form the score pattern 98 and/or marking pattern 200 and yield those spatial relationships. For instance, the controller 270 can operate the robot arm 266 (and scoring tool 262 affixed thereto) to form the score pattern 98 on the skin body 80, the spatial relationships described above can be predetermined and stored in a memory of the controller 270, and then the controller 270 can operate the robot arm 266 (and laser etching device 264 affixed thereto) to form the marking pattern 200 to yield the spatial relationships. In other embodiments, the score pattern 98 and marking pattern 200 can both be formed, and then one or more spatial relationships between the score pattern 98 and marking pattern 200 can be determined. In either case, the score pattern 98 and marking pattern 200 will have one or more known spatial relationships, which can facilitate later steps of the method 100 described below.

The marking pattern 200 in the present embodiment is formed via laser etching using a conventional laser etching device 264, which will emit a laser beam toward the skin body 80 to melt (and in some cases burn or vaporize) portions of the skin body 80, thereby forming the visible markings 202. It is to be appreciated that operation of the laser etching device 264 may depend on the material and/or color of the skin body 80. That is, different materials require different amounts of energy per area to melt the materials and produce visible markings. Moreover, lighter colors will require more energy per area to produce visible markings, since the laser beam will have to burn the skin body 80 to help distinguish the lighter colors. Accordingly, operation of the laser etching device 264 to produce the marking pattern 200 can be based on the material and/or color of the skin body 80.

However, the score pattern 98 and marking pattern 200 can be formed by other methods without departing from the scope of the disclosure. For example, the marking pattern 200 may be drawn on the skin body 80 using a marker or some other writing utensil. Still further, it is to be appreciated that the skin 20 may be provided at step 104 in a pre-formed condition, including the score pattern 98 and marking pattern 200.

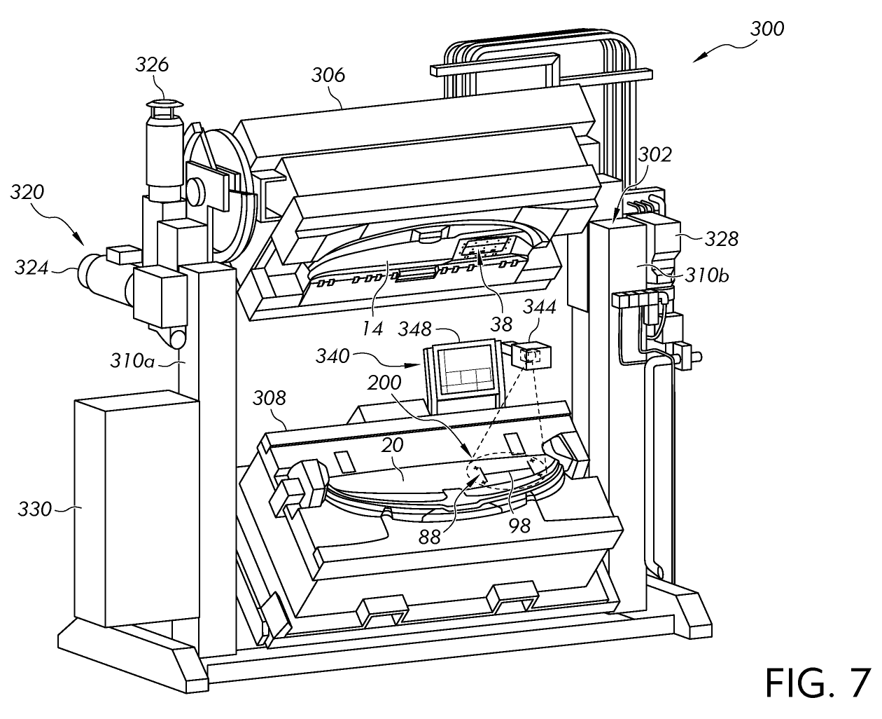

The method 100 next includes a step 106 of providing an assembling machine 300 for stacking and assembling the support substrate 14 and skin 20. As shown in FIG. 7, the assembling machine 300 in the present embodiment includes a support base 302 and upper and lower machine (e.g., mold) bodies 306, 308 that are movably coupled to the support base 302. In particular, the support base 302 includes first and second support columns 310a, 310b, and each machine body 306, 308 is movably coupled at opposite ends to the first and second support columns 310a, 310b such that the machine body 306, 308 is translatable and rotatable relative to the first and second support columns 310a, 310b. In this manner, the upper and lower machine bodies 306, 308 are movable relative to each other and the support base 302.

The assembling machine 300 further includes a motor system 320 that is operable to move (e.g., translate and/or rotate) each machine body 306, 308 relative to the support base 302. In particular, the motor system 320 can include one or more motors 324, 326, 328 wherein each motor 324, 326, 328 is operatively coupled to one or both machine bodies 306, 308 via an associated transmission system and is operable to move (e.g., translate and/or rotate) its associated machine body/bodies 306, 308 relative to the support base 302. Moreover, the assembling machine 300 includes a controller 330 that is operatively coupled to the motor system 320 for controlling its operation.

As discussed further below, the support substrate 14 and skin 20 can be respectively loaded on the upper and lower machine bodies 306, 308 in a desired arrangement, and then the motor system 320 can be operated to move the upper and lower machine bodies 306, 308 relative to each other until the support substrate 14 and skin 20 assume a stacked configuration for assembly. However, it is to be appreciated that the assembling machine 300 may comprise other configurations without departing from the scope of the disclosure. Broadly speaking, the machine 300 can comprise any configuration having first and second machine bodies, wherein at least one machine body is movable (e.g., manually or via a motor system) relative to the other.

The method 100 next includes a step 108 of loading the support substrate 14 and skin 20 respectively on the upper and lower machine bodies 306, 308 in a desired arrangement. As noted above, it is preferable that the weakened portions 38, 88 of the support substrate 14 and skin 20 are aligned with each other once assembled to ensure proper deployment of the airbag through the door portions 36, 86 of the support substrate 14 and skin 20. To facilitate this alignment, the support substrate 14 and skin 20 can be respectively arranged on the upper and lower machine bodies 306, 308 such that they satisfy respective predetermined conditions that will ensure proper alignment of the weakened portions 38, 88 once the machine bodies 306, 308 are moved to arrange the support substrate 14 and skin 20 in the stacked configuration.

For example, as shown in FIG. 7, the support substrate 14 (with the reinforcement member 16 optionally attached thereto) can be arranged relative to the upper machine body 306 such that it satisfies a predetermined condition wherein the support substrate 14 mates with a mold portion (e.g., cavity) a bottom side of the machine body 306. Notably, the relative rigidity and small tolerances of the support substrate 14 (as compared to the skin 20) can help facilitate proper mating of the support substrate 14 with the machine body 306 and ensure that the weakened portion 38 of the support substrate 14 is in a predetermined and known location relative to the upper machine body 306 once loaded. Moreover, it is relatively easy for an operator to confirm proper alignment of the weakened portion 38 since it easily visible. Furthermore, in some examples, the substrate 14 can have 2-way and 4-way locators that help control alignment of the substrate 14 relative to the upper machine body 306.

Once the support substrate 14 has been properly arranged relative to the upper machine body 306 to satisfy the predetermined condition, the support substrate 14 can be fixed relative to the machine body 306 by, for example, operating vacuum ports on the bottom side of the machine body 306 to create a vacuum that draws the support substrate 14 against the machine body 306. Moreover, the reinforcement member 16 may be optionally attached to the support substrate 14 in the manner described further above.

The skin 20 can then be arranged relative to the lower machine body 308 such that it mates with a mold portion (e.g., protuberance) on an upper side of the machine body 308. The skin 20 is more flexible and can have relatively larger tolerances than the support substrate 14, particularly at its weakened portion 88. Moreover, the weakened portion 88 can be difficult to visually detect and confirm proper alignment relative to the machine body 308, since the depth of its score pattern 98 is relatively small. However, the marking pattern 200 can be easier to detect and has a known spatial relationship with the weakened portion 88 as discussed above. Accordingly, the skin 20 can be arranged relative to the lower machine body 308 until the marking pattern 200 satisfies a predetermined condition that yields proper alignment of the weakened portion 88.

More specifically, knowing the location of the support substrate 14 (when loaded on the upper machine body 306 in its predetermined condition) and the spatial relationship between the weakened portion 88 and marking pattern 200 of the skin 20, one can predetermine a condition for the marking pattern 200 based on those known characteristics that will properly align the weakened portions 38, 88 of the support substrate 14 and skin 20 for assembly. For example, if a portion (e.g., marking 202) of the marking pattern 200 is spaced from the weakened portion 88 by a known distance (e.g., 2 inches) in a horizontal direction (e.g., left or right), the predetermined condition for the marking pattern 200 may comprise a condition in which that portion of the marking pattern 200 is horizontally offset from the weakened portion 38 of the support substrate 14 by that known distance (e.g., 2 inches) in the same direction, thus aligning the weakened portions 38, 88 of the support substrate 14 and skin 20 in the horizontal direction. However, it is to be appreciated that the predetermined condition for the marking pattern 200 may comprise additional and/or alternative conditions without departing from the scope of the disclosure. Ultimately, the predetermined condition for the marking pattern 200 can depend on many variables such as, for example, the known spatial relationship(s) between the between the weakened portion 88 and marking pattern 200 of the skin 20, how the weakened portion 88 should be arranged on the lower machine body 308 for proper alignment with the weakened portion 38 of the support substrate 14, and how the upper and lower machine bodies 306, 308 may later move in the assembling process.

Once the predetermined condition for the marking pattern 200 is established, an operator can arrange the skin 20 relative to the lower machine body 308 until the marking pattern 200 satisfies the condition. In some examples, the operator can simply visually confirm that the marking pattern 200 satisfies the predetermined condition. In other examples, the assembling machine 300 can be configured to detect the marking pattern 200 and determine if it satisfies the predetermined condition.

For instance, the assembling machine 300 in the present embodiment includes a marking detection system 340 having a camera 344 that is operable to capture an optical image (e.g., video or photo) of the skin 20 when placed on the lower machine body 308, and a display 348 that is configured to display the image captured by the camera 344. The controller 330 of the assembling machine 300 is part of the marking detection system 340, and is operatively coupled to both the camera 344 and display 348. Moreover, the predetermined condition for the marking pattern 200 can be stored in a memory of the controller 330.

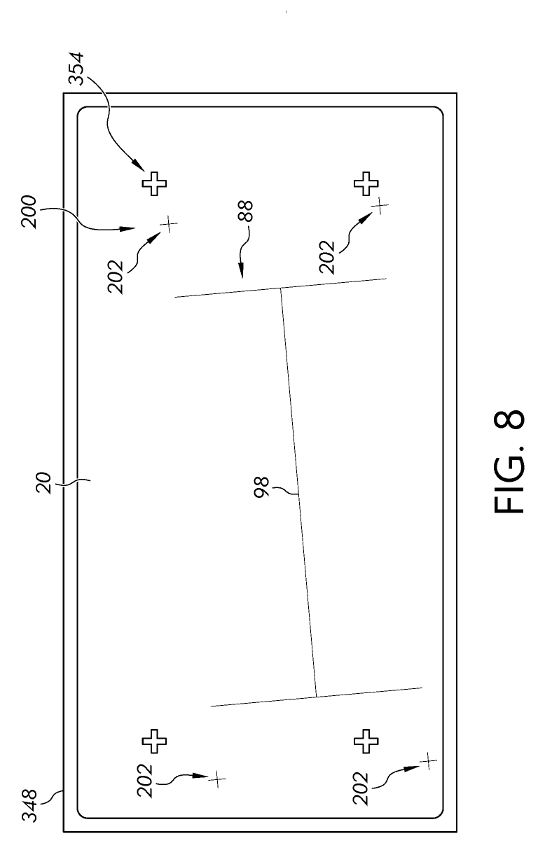

As the skin 20 is loaded onto the lower machine body 308 by the operator, the camera 344 can capture an image of the skin 20 and output that image to the controller 330, which in turn can operate the display 348 to show the image (see e.g., FIG. 8). Moreover, the controller 330 can further operate the display 348 to show a target 354 corresponding to the predetermined condition in which the marking pattern 200 should be arranged to ensure proper alignment of the skin 20. The operator can continue arranging the skin 20 relative to the lower machine body 308 until the marking pattern 200 aligns with the target 354 and satisfies the predetermined condition. For example, the operator can arrange the skin 20 until all of the markings 202 are located within their respective targets 354.

Throughout the process above, the controller 330 can compare the image of the skin 20 with the predetermined condition and determine if the marking pattern 200 satisfies the predetermined condition. As noted above, each marking 202 of the marking pattern 200 preferably comprises two or more lines that are transverse to each other and intersect or meet at a common end point. For example, each marking 202 in the present embodiment comprises two lines that are perpendicular to and intersect each other to form a crosshair shape. Such a configuration of transverse lines can enable the controller 330 to easily detect the marking pattern 200 and determine if it satisfies the predetermined condition, since the transverse lines are relatively easier to detect than other configurations of non-intersecting lines, points, etc. Moreover, the controller 330 can operate the display 348 to indicate whether the predetermined condition is satisfied. For example, if the predetermined condition is not satisfied, the controller 330 can operate the display 348 to show the target 354 in a red color. Conversely, if the predetermined condition is satisfied, the controller 330 can operate the display 348 to show the target 354 in a green color.

The marking detection system 340 can thus capture an image of the marking pattern 200, determine if the marking pattern 200 satisfies the predetermined condition, and then indicate whether the predetermined condition is satisfied. However, it is to be appreciated that the marking detection system 340 can comprise other configurations for facilitating these functions without departing from the scope of the disclosure. For instance, the marking detection system 340 may simply comprise one or more optical sensors that can detect whether the marking pattern 200 satisfies the predetermined condition, and then provide an output indicating whether the predetermined condition is satisfied.

Once the skin 20 has been properly arranged relative to the lower machine body 308 to satisfy the predetermined condition, the skin 20 can be fixed relative to the machine body 308 by, for example, operating vacuum ports on the upper side of the machine body 308 to create a vacuum that draws the skin 20 against the machine body 308.

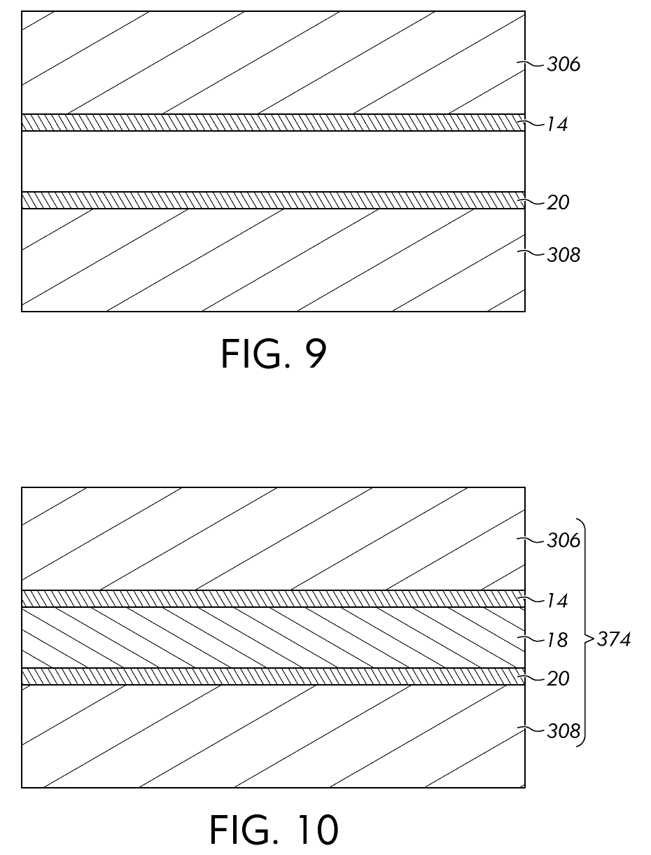

The method 100 next includes a step 110 of moving at least one of the upper and lower machine bodies 306, 308 relative to the other until the machine bodies 306, 308 assume a stacking configuration. For example, both machine bodies 306, 308 can be rotated from their positions shown in FIG. 7 until the machine bodies 306, 308 are generally horizontal and parallel to each other. Then, the upper machine body 306 can be lowered until the machine bodies 306, 308 assume the stacking configuration shown in FIG. 9. In this configuration, the support substrate 14 will be arranged directly above (but slightly spaced from) the skin 20. Moreover, the loading and alignment of the support substrate 14 and skin 20 in step 108 will ensure that the stacking configuration of the machine bodies 306, 308 in FIG. 9 results in proper alignment of the weakened portions 38, 88 of the support substrate 14 and skin 20.

It is to be appreciated that the stacking configuration assumed in step 110 can be any configuration in which the support substrate 14 and skin 20 are stacked along a particular direction (e.g., vertical), such that the support substrate 14 and skin 20 overlap in the stacking direction. Moreover, the support substrate 14 and skin 20 can be spaced from each other in the stacking configuration as shown in FIG. 9, or the support substrate 14 and skin 20 may directly abut each other in the stacking configuration.

The method 100 next includes a step 112 of fixing the support substrate 14 and skin 20 relative to each other while in the machine bodies 306, 308 are in stacking configuration. For example, a liquid foam material (e.g., polypropylene and/or polyethylene) may be injected between the support substrate 14 and skin 20 to fill the space therebetween, and then the liquid foam material can be hardened or cured to form the foam layer 18 (see FIG. 10), which fixes the skin 20 to the support substrate 14. Once fixed together, the support substrate 14, skin 20, and foam layer 18 will collectively form a stacked assembly 374. In addition or alternatively, the support substrate 14 and skin 20 can be fixed to each other using other fixing means such as adhesive and/or fasteners.

The method 100 can next include a step 114 of removing the stacked assembly 374 from the assembling machine 300. In particular, the vacuum fixing the support substrate 14 and skin 20 to the upper and lower machine 306, 308 can be ceased, and then at least one of the machine bodies 306, 308 can be translated away from the other to provide access to the stacked assembly 374. An operator can then remove the stacked assembly 374 from the assembling machine 300.

Lastly, the method 100 can include a step 116 of fixing the airbag module 12 to rear side of the support substrate 14, thereby completing the trim assembly 10. However, it is to be appreciated that the airbag module 12 may be affixed to the support substrate 14 at earlier stages in the method. For example, the airbag module 12 may be affixed to the support substrate 14 before the support substrate 14 is loaded onto the upper machine body 306 of the assembling machine 300.

The method 100 as described above can thus enable proper alignment of the weakened portions 38, 88, by applying a marking pattern 200 to the skin 20 such that it has a known spatial relationship with the weakened portion 88, and then using that marking pattern 200 and its known spatial relationship with the weakened portion 88 to facilitate alignment of the skin 20. However, it is to be appreciated that various modifications can be made to the method 100 to yield similar benefits. Moreover, the method 100 described above can be similarly useful for manufacturing other stacked assemblies having weakened portions that are difficult to visually detect and align.

Still further, it is to be appreciated that the method 100 described above can be used to manufacture multiple (e.g., first and second) stacked assemblies. That is, each stacked assembly can be formed using the method 100 described above. In some cases, the components of the stacked assemblies may have different properties. For example, the score patterns 98 of the stacked assemblies may be different in shape from each other. In such examples, the score patterns 98 and marking patterns 200 of the stacked assemblies can be formed to have a common spatial relationship, such that the spatial relationships between the score pattern 98 and marking pattern 200 for every stacked assembly are the same. For instance, each marking 202 of the marking pattern 200 can be spaced the same distance from its associated score pattern 98. This can enable each score pattern 98 to be consistently aligned using the same, known spatial relationship for every stacked assembly.

As another example, the materials and/or colors of the skin 20 for the stacked assemblies can be different from each other. As noted above, different materials and/or colors can require different amounts of energy per area to laser-etch the materials and produce visible markings. Accordingly, the marking pattern 200 for each skin 20 can be laser etched based on the material and/or color of the skin body 80, in order to ensure that the marking pattern 200 is properly formed and visible.

For example, the skin 20 of a first stacked assembly can comprise a component body 80 having a first material, and the skin 20 of a second stacked assembly can comprise a component body 80 having a second material that is different from the first material and requires more energy per area to laser etch and produce visible markings. When forming the marking 200 for the first stacked assembly, the controller 270 of the skin-processing machine 250 can operate the laser etching device 264 to apply a first amount of energy per area to the component body 80 for the first stacked assembly. Moreover, when forming the marking 200 for the second stacked assembly, the controller 270 of the skin-processing machine 250 can operate the laser etching device 264 to apply a second amount of energy per area to the component body 80 for the second stacked assembly, wherein the second amount of energy per area is greater than the first amount of energy per area. In particular, the controller 270 can adjust an intensity of the laser etching device 264 and/or a speed of the robot arm 266 (and thus the laser etching device 264 affixed thereto) in order to apply these different amounts of energy per area for the first and second stacking assemblies.

As another example, the skin 20 of a first stacked assembly can comprise a component body 80 having a first color, and the skin 20 of a second stacked assembly can comprise a component body 80 having a second color that is lighter than the first color and requires more energy per area to produce visible markings. When forming the marking 200 for the first stacked assembly, the controller 270 of the skin-processing machine 250 can operate the laser etching device 264 to apply a first amount of energy per area to the component body 80 for the first stacked assembly. Moreover, when forming the marking 200 for the second stacked assembly, the controller 270 of the skin-processing machine 250 can operate the laser etching device 264 to apply a second amount of energy per area to the component body 80 for the second stacked assembly, wherein the second amount of energy per area is greater than the first amount of energy per area. In particular, the controller 270 can adjust an intensity and/or speed of the laser etching device 264 in order to apply these different amounts of energy per area for the first and second stacking assemblies.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A method of manufacturing a stacked assembly using an assembling machine having a first machine body and a second machine body, the method comprising:
providing a first component;
providing a second component to be stacked with the first component, the second component having a score pattern and a marking pattern formed thereon;
arranging the first component relative to the first machine body, and then fixing the first component relative to the first machine body;
arranging the second component relative to the second machine body such that the marking pattern satisfies a predetermined condition, and then fixing the second component relative to the second machine body while the marking pattern satisfies the predetermined condition;
moving at least one of the first machine body and second machine body relative to the other of the first machine body and second machine body such that the first machine body and second machine body assume a stacking configuration; and
fixing the second component relative to the first component while the first machine body and second machine body are in the stacking configuration.

2. The method according to claim 1, wherein the score pattern and marking pattern have a spatial relationship, and the predetermined condition is based on the spatial relationship.

3. The method according to claim 2, wherein the assembling machine includes a marking detection system configured to determine if the marking pattern satisfies the predetermined condition, the marking detection system comprising a controller with a memory that stores the predetermined condition.

4. The method according to claim 3, wherein the marking detection system further includes:
a camera that is operable to capture an image of the marking pattern, and
a display that is operable to display the image of the marking pattern,
wherein the controller is operatively coupled to the camera and display.

5. The method according to claim 4, wherein the controller is configured to operate the display to indicate whether the predetermined condition is satisfied.

6. The method according to claim 4, wherein the controller is configured to operate the display to show a target corresponding to the predetermined condition.

7. The method according to claim 2, wherein the step of providing the second component includes:
providing a component body,
scoring the component body to form the score pattern, and
forming the marking pattern on the component body.

8. The method according to claim 7, wherein the spatial relationship is predetermined prior to forming the score pattern and/or marking pattern, and the score pattern and marking pattern are formed to have the spatial relationship.

9. The method according to claim 7, wherein the spatial relationship is determined after the score pattern and marking pattern are formed.

10. The method according to claim 7, wherein the marking pattern is formed on the component body via laser etching.

11. The method according to claim 10, wherein the marking pattern is formed on the component body based on a material and/or color of the component body.

12. The method according to claim 10, wherein the step of providing the second component includes using a processing machine to form the marking pattern on the component body, the processing machine comprising a laser etching device and a controller operatively coupled to the laser etching device,
wherein the spatial relation is stored in a memory of the controller, and the controller is configured to operate the laser etching device to form the marking pattern such that the score pattern and marking pattern have the spatial relationship.

13. The method according to claim 1, wherein the marking pattern comprises one or more markings, each marking comprising a first line and a second line that is transverse to the second line and meets or intersects with the first line.

14. The method according to claim 1, wherein a foam material is injected between the first component and the second component while the first machine body and second machine body are in the stacking configuration.

15. The method according to claim 1, wherein:
the stacked assembly is a vehicle trim assembly,
the first component is a support substrate of the vehicle trim assembly, and
the second component is a skin of the vehicle trim assembly.

16. The method according to claim 1, wherein an airbag module is affixed to the first component.

17. A method of manufacturing a first stacked assembly and a second stacked assembly using an assembling machine having a first machine body and a second machine body, wherein the first stacked assembly and second stacked assembly are each manufactured by:
providing a first component;
providing a second component to be stacked with the first component, the second component having a score pattern and a marking pattern formed thereon such that the score pattern and marking pattern have a spatial relationship;
arranging the first component relative to the first machine body, and then fixing the first component relative to the first machine body;
arranging the second component relative to the second machine body such that the marking pattern satisfies a predetermined condition that is based on the spatial relationship, and then fixing the second component relative to the second machine body while the marking pattern satisfies the predetermined condition;
moving at least one of the first machine body and second machine body relative to the other of the first machine body and second machine body such that the first machine body and second machine body assume a stacking configuration; and
fixing the second component relative to the first component while the first machine body and second machine body are in the stacking configuration,
wherein the spatial relationship between the score pattern and marking pattern of the first stacked assembly is the same as the spatial relationship between the score pattern and marking pattern of the second stacked assembly.

18. The method according to claim 17, wherein the step of providing the second component includes:
providing a component body,
scoring the component body to form the score pattern, and
operating a laser etching device based on a material and/or color of the component body to form the marking pattern on the component body via laser etching.

19. The method according to claim 18, wherein:
the component body for the first stacked assembly comprises a first material,
the component body for the second stacked assembly comprises a second material that is different from the first material,
when manufacturing the first stacked assembly, the laser etching device is operated to apply a first amount of energy per area to the component body for the first stacked assembly, and
when manufacturing the first stacked assembly, the laser etching device is operated to apply a second amount of energy per area to the component body for the second stacked assembly that is different from the first amount of energy per area.

20. The method according to claim 18, wherein:
the component body for the first stacked assembly comprises a first color,
the component body for the second stacked assembly comprises a second color that is lighter than the first color,
when manufacturing the first stacked assembly, the laser etching device is operated to apply a first amount of energy per area to the component body for the first stacked assembly, and
when manufacturing the first stacked assembly, the laser etching device is operated to apply a second amount of energy per area to the component body for the second stacked assembly that is greater than the first amount of energy per area.
